(19) United States
(12) Patent Application Publication
(10) Pub. No.: US 2015/0347798 A1
(43) Pub. Date: Dec. 3, 2015

(54) POINT-OF-TRANSACTION WORKSTATION FOR, AND METHOD OF, IMAGING SHEET-LIKE TARGETS

(71) Applicant: SYMBOL TECHNOLOGIES, INC., SCHAUMBURG, IL (US)

(72) Inventor: Dariusz J. Madej, Shoreham, NY (US)

(73) Assignee: SYMBOL TECHNOLOGIES, INC., SCHAUMBURG, IL (US)

(21) Appl. No.: 14/290,294

(22) Filed: May 29, 2014

(51) Int. Cl. G06K 7/10

(52) U.S. Cl. CPC G06K 7/10831; G06K 7/10841

(57) ABSTRACT

A workstation processes a product by imaging an indicium associated with the product in a transaction, and images a sheet-like target associated with the transaction. A window is supported in a window plane in contact with the target during target imaging. An imaging assembly captures light from the indicia during product processing, and from the target during target imaging, over a plurality of fields of view extending along different directions through the window. Each field bounds an area in the window plane that is smaller than the entire target. At least one pair of the fields partially overlaps each other in the window plane. The fields overlap contiguous portions of the target during target imaging. The light from the contiguous portions is captured by the imaging assembly as a plurality of target images. A controller compiles the target images into a single output image indicative of the target.

### BACKGROUND OF THE INVENTION

The present disclosure relates generally to a point-of-transaction workstation operative for imaging indicia, such as bar code symbols, associated with three-dimensional products to be processed in a transaction and identified, and, more particularly, to a bi-optical workstation for, and a method of, additionally imaging generally planar, sheet-like targets, such as checks, medical prescriptions, drivers' licenses, receipts, credit/debit/loyalty cards, coupons, and like documents, sheets, forms and cards, that are associated with the transaction.

It is known to use one or more solid-state imagers or cameras in a single window, flat-bed workstation, or in a dual window or bi-optical workstation to electro-optically image indicia, such as bar code symbols, associated with three-dimensional products to be processed, e.g., purchased, in a transaction and identified at a point-of-transaction workstation provided at a countertop of a checkout stand in supermarkets, warehouse clubs, department stores, and other kinds of retailers and other kinds of businesses, such as libraries and factories. The products are typically slid or moved in various directions in a swipe mode by an operator across, or presented in a presentation mode to a central region of, a generally horizontal window that faces upwardly above the countertop and/or a generally vertical or upright window that rises above the countertop. The products may be positioned anywhere within a three-dimensional scan zone, either in contact with, or held at a working distance away from, either window during such movement or presentation. The scan zone extends above the horizontal window and in front of the upright window as close as possible to the countertop, and sufficiently high above the countertop, and as wide as possible across the width of the countertop.

In order to provide full imaging coverage throughout the scan zone to enable reliable imaging of indicia that could be positioned anywhere on all six sides of a three-dimensional product, it is known to occupy the scan zone with a plurality of fields of view, either from a corresponding plurality of the imagers, or from a single imager whose single field of view is split into a plurality of fields of view. The plurality of fields of view project into space and diverge at different angles away from either window. Typically, a center field of view passes through a central region of either window, and right and left fields of view pass through left and right side regions of either window. Each field of view is typically narrow, e.g., subtends a solid angle of about eight degrees, and grows in volume in order to cover indicia on products that are positioned not only on the windows, but also many inches therefrom. When return light from an indicium is captured through either window as an image over at least one of the fields of view, the image is then processed and, if the indicium is a symbol, the symbol is then decoded and read, thereby identifying the product.

As advantageous as such imaging workstations have been in imaging indicia on three-dimensional products to complete a transaction, it is sometimes desired that they should have the added capability of imaging other targets, especially generally planar, sheet-like targets, such as checks, medical prescriptions, drivers' licenses, receipts, credit/debit/loyalty cards, coupons, and like documents, sheets, forms and cards, that are associated with the transaction. For example, a retailer may want to capture an image of a check used to pay for the transaction, or of a medical prescription used to order drugs prescribed in the transaction, and would prefer to use the available workstation itself for that purpose, rather than an additional camera or other auxiliary device. Yet, each of the narrow fields of view, each of which is sufficiently large enough to image an entire indicium such as a bar code symbol, is typically too small to capture the image of the entire check or prescription. By way of example, a standard check approximately measures about 2.5 inches by 5.75 inches, and a standard prescription approximately measures about 4 inches by 5.125 inches. A typical standard symbol has smaller dimensions than these and, hence, each narrow field of view in the known workstations does not have the capability to image entire targets whose dimensions are larger than standard symbols.

Accordingly, there is a need to use such workstations to also image other targets, especially generally planar, sheet-like targets, and to avoid using auxiliary devices for that purpose.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a perspective view of a dual window, bi-optical, point-of-transaction workstation or imaging system operative for imaging and reading indicia on three-dimensional products passing through the workstation, and for additionally imaging generally planar, sheet-like targets in accordance with this invention.

FIG. 2 is a perspective view of an imaging assembly inside the workstation of FIG. 1 and operative for directing a plurality of fields of view along imaging axes through a horizontal window of the workstation.

FIG. 3 is a perspective view depicting the fields of view of FIG. 2 in three-dimensional form through the horizontal window.

FIG. 4 is a sectional view depicting the placement of a calibration target during a calibration mode, and of a sheet-like target during a subsequent target imaging mode.

FIG. 5 is a top plan view of the images taken of the calibration target by the fields of view of FIG. 3.

FIG. 6 is a top plan view of the images taken of the sheet-like target by the fields of view of FIG. 3.

FIG. 7 is a top plan view of a composite image of the sheet-like target derived from the images of FIG. 6.

FIGS. 8A and 8B together constitute a flow chart depicting the steps performed in calibrating a calibration target in accordance with the method of this invention.

FIGS. 9A and 9B together constitute a flow chart depicting the post-calibration steps performed in additionally imaging generally planar, sheet-like targets in accordance with the method of this invention.

Skilled artisans will appreciate that elements in the figures are illustrated for simplicity and clarity and have not necessarily been drawn to scale. For example, the dimensions and locations of some of the elements in the figures may be exaggerated relative to other elements to help to improve understanding of embodiments of the present invention.

The system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

One aspect of the present disclosure relates to a point-of-transaction workstation for processing a product by imaging an indicium, e.g., a bar code symbol, associated with the product in a transaction, and for also imaging a stationary, sheet-like target, e.g., a check, a medical prescription, a driver's license, a receipt, a credit/debit/loyalty card, a coupon, and a like document, sheet, form and card, associated with the transaction. The workstation includes a housing, and at least one light-transmissive, generally planar window supported in a window plane by the housing, and being in surface area contact with the sheet-like target during imaging of the sheet-like target. In the case of a bi-optical workstation, the at least one window can be the horizontal or the upright window.

The workstation further includes an imaging assembly having at least one solid-state imager stationarily supported by the housing. The imaging assembly is operative for capturing return light from the indicia during processing of the product, and from the sheet-like target during imaging of the sheet-like target, over a plurality of stationary fields of view extending along different directions through the at least one window. Each field of view bounds an area in the window plane that is smaller than the entire sheet-like target. At least one pair of the fields of view partially overlaps each other in the window plane. The plurality of the fields of view overlap a plurality of contiguous portions of the sheet-like target in stationary contact with the at least one window during imaging of the sheet-like target. The return light from the plurality of the contiguous portions is captured by the imaging assembly as a plurality of target images. The workstation further includes a controller operatively connected to the at least one imager, for compiling the target images into a single output image indicative of the sheet-like target.

Advantageously, the fields of view include a center field of view that passes through a central region of the at least one window to enable the imaging assembly to capture a center target image, a right field of view that passes through a left side region of the at least one window to enable the imaging assembly to capture a right target image, and a left field of view that passes through a right side region of the at least one window to enable the imaging assembly to capture a left target image. The controller rectifies the right and left target images to account for mirror reflection, and also processes the right and left target images to correct for perspective distortion.

The controller compiles the target images into the single output image by using mapping matrices obtained during an advance calibration mode in which a stationary, sheet-like calibration target, e.g., a two-dimensional DataMatrix symbol, is placed in surface area contact with the at least one window to enable the imaging assembly to capture center, right and left calibration target images, and in which the controller computes and stores the mapping matrices indicative of the relationships among the calibration target images.

Still another aspect of the present disclosure relates to a method of processing a product by imaging an indicium associated with the product in a transaction, and of imaging a stationary, sheet-like target associated with the transaction. The method is performed by supporting at least one light-transmissive, generally planar window in a window plane; by placing the sheet-like target in surface area contact with the at least one window during imaging of the sheet-like target; and by capturing return light from the indicia during processing of the product, and from the sheet-like target during imaging of the sheet-like target, with an imaging assembly having at least one solid-state imager, over a plurality of stationary fields of view extending along different directions through the at least one window. Each field of view bounds an area in the window plane that is smaller than the entire sheet-like target. At least one pair of the fields of view partially overlaps each other in the window plane. The plurality of the fields of view overlap a plurality of contiguous portions of the sheet-like target in stationary contact with the at least one window during imaging of the sheet-like target. The return light from the plurality of the contiguous portions is captured by the imaging assembly as a plurality of target images. The method is further performed by compiling the target images into a single output image indicative of the sheet-like target.

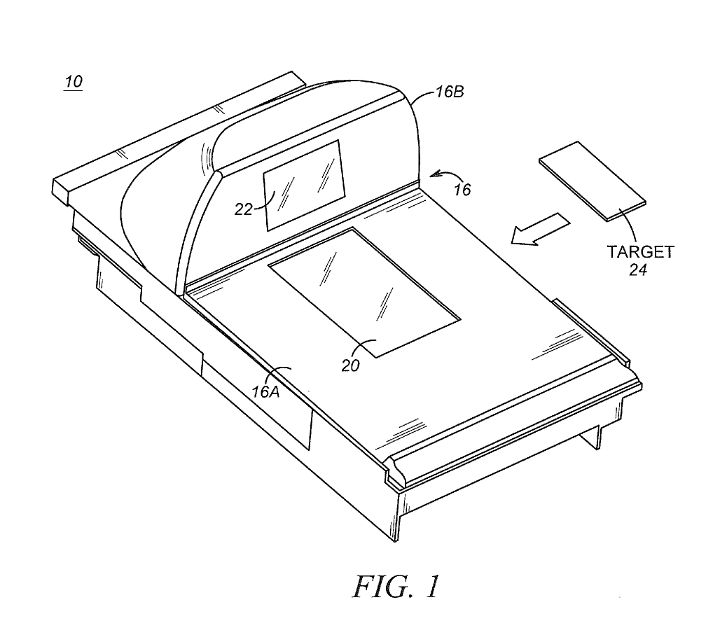

Referring now to FIG. 1, reference numeral 10 generally identifies a dual window, bi-optical, point-of-transaction workstation for electro-optically imaging indicia, such as UPC bar code symbols, associated with multi-sided, three-dimensional products, and is typically used by retailers to process transactions involving the purchase of the products bearing, or printed with, the identifying indicia. The workstation 10 includes a housing 16 having a generally horizontal window 20 located in a generally horizontal plane and supported by a horizontal housing portion 16A, and an upright window 22 located in a generally upright plane that intersects the generally horizontal plane and supported by a raised housing portion 16B. The upright plane may lie in a vertical plane, or be slightly rearwardly or forwardly inclined relative to the vertical plane. The upright window 22 is preferably recessed within its housing portion 16B to resist scratching. By way of numerical example, the generally horizontal window 20 measures about four inches in width by about six inches in length, while the generally upright window 22 measures about six inches in width by about eight inches in length. The products are passed by an operator or a customer through a scan zone, which occupies the space at and above the horizontal window 20, and also occupies the space at and in front of the upright window 22. Other housings having different shapes, with one or more windows, are also within the spirit of this invention. For example, a flat-bed workstation having a single horizontal window can also benefit from this invention.

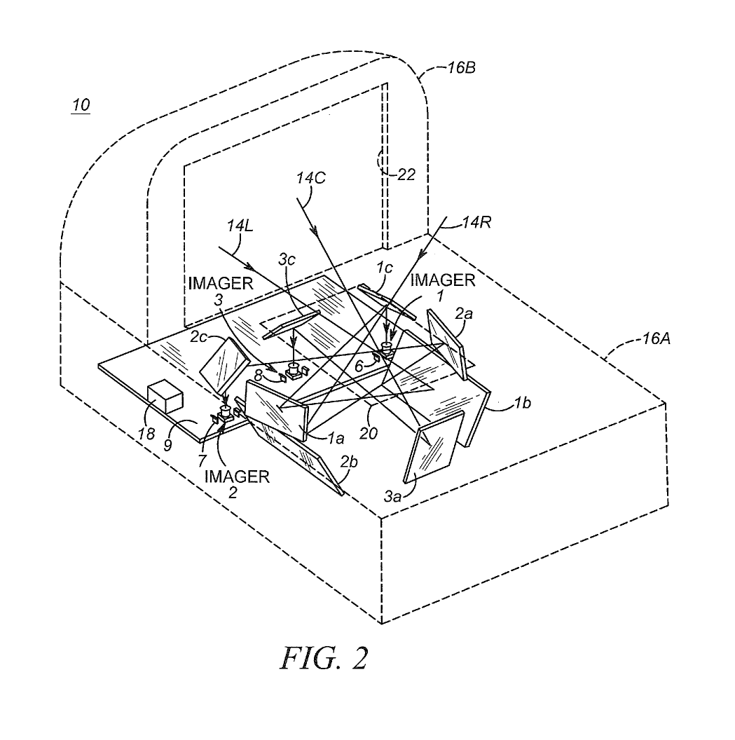

As shown in FIG. 2, an imaging assembly having at least one solid-state imager is stationarily supported in the housing 16, and is operative for capturing return light from the indicia during processing of the products over a plurality of stationary fields of view extending along different directions through the horizontal window 20. Three imagers 1, 2, and 3, and their respective illuminators 6, 7 and 8, are commonly mounted on a printed circuit board (PCB) 9 that lies in a generally horizontal plane generally parallel to, and below, the generally horizontal window 20. Each imager is a solid-state array, preferably a charge coupled device (CCD) array, or a complementary metal oxide semiconductor (CMOS) array, having addressable image sensors or pixels arranged in mutually orthogonal rows and columns in a two-dimensional array. Each illuminator is preferably one or more light sources, e.g., surface-mounted, light emitting diodes (LEDs), located at each imager to uniformly illuminate the respective field of view.

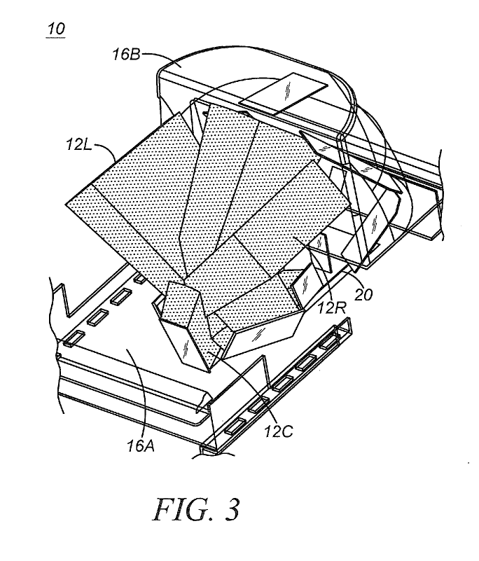

Imager 1 faces generally vertically upward toward an inclined folding mirror 1c directly overhead at a right side of the PCB 9. The folding mirror 1c faces another inclined narrow folding mirror 1a located at a left side of the PCB 9. The folding mirror 1a faces still another inclined wide folding mirror 1b adjacent the mirror 1c. The folding mirror 1b faces out through the generally horizontal window 20 toward the left side of the workstation 10. Imager 1 has a left field of view 12L (see FIG. 3) that extends along an imaging axis 14L (see FIG. 2).

Imager 2 and its associated optics is mirror symmetrical to imager 1 and its associated optics. Imager 2 faces generally vertically upward toward an inclined folding mirror 2c directly overhead at the left side of the PCB 9. The folding mirror 2c faces another inclined narrow folding mirror 2a located at the right side of the PCB 9. The folding mirror 2a faces still another inclined wide folding mirror 2b adjacent the mirror 2c. The folding mirror 2b faces out through the generally horizontal window 20 toward the right side of the workstation 10. Imager 2 has a right field of view 12R (see FIG. 3) that extends along an imaging axis 14R (see FIG. 2).

Imager 3 and its associated optics are located generally centrally between imagers 1 and 2 and their associated optics. Imager 3 faces generally vertically upward toward an inclined folding mirror 3c directly overhead generally centrally of the window 20 at one end thereof. The folding mirror 3c faces another inclined folding mirror 3a located at the opposite end of the window 20. The folding mirror 3a faces centrally out through the window 20 in an upward direction toward the raised housing portion 16B. Imager 3 has a center field of view 12C (see FIG. 3) that extends along an imaging axis 14C (see FIG. 2).

As described so far, a trio of imagers 1, 2 and 3 capture light along different, intersecting fields of view 12L, 12R and 12C along different directions through the generally horizontal window 20. Analogously, an additional trio of imagers (not illustrated) capture light along different, intersecting fields of view along different directions through the generally vertical window 22. Although three imagers have been described for each window, a single imager whose single field of view is split into three fields of view can also be implemented. One or more optical splitters and mirrors can be arranged to capture light along different, intersecting fields of view along different directions through a window.

In use, an operator, such as a clerk working at a supermarket checkout counter or a customer at a self-service counter, processes a product bearing a UPC symbol thereon, past the windows 20, 22 by swiping the product across a respective window in the abovementioned swipe mode, or by presenting the product at the respective window in the abovementioned presentation mode. The symbol may be located on any of the top, bottom, right, left, front and rear, sides of the product, and at least one, if not more, of the imagers will capture the illumination light reflected, scattered, or otherwise returning from the symbol through one or both windows.

As also shown in FIG. 2, the imagers and their associated illuminators are operatively connected to a programmed microprocessor or controller 18 operative for controlling the operation of these and other components. In operation, the controller 18 sends a command signal to energize the illuminators for a short exposure time period, say 500 microseconds or less, and energizes and exposes the imagers to collect the return light, e.g., illumination light and/or ambient light, from the symbol only during said exposure time period. A typical array needs about 18-33 milliseconds to acquire an entire image and operates at a frame rate of about 30-60 frames per second. Preferably, the controller 18 is the same as the one used for decoding the return light scattered from the symbol.

As described above, it is sometimes desired for the workstation 10 to have the added capability of imaging other targets, especially a generally planar, sheet-like target 24 (see FIG. 1), such as a check, a medical prescription, a driver's license, a receipt, a credit/debit/loyalty card, a coupon, and a like document, sheet, form and card, that is associated with the transaction. For example, a retailer may want to capture an image of a check used to pay for the transaction, or of a medical prescription used to order drugs prescribed in the transaction, and would prefer to use the available workstation 10 itself for that purpose, rather than an additional camera or other auxiliary device. Yet, each of the above-described fields of view 12L, 12R and 12C is relatively narrow in shape and relatively small in size; in practice, each subtends a solid angle of only about eight degrees. Each such narrow field of view is sufficiently large enough to image an entire indicium such as a bar code symbol, but is typically too small to capture the image of an entire check or prescription. By way of example, a standard check approximately measures about 2.5 inches by 5.75 inches, and a standard prescription approximately measures about 4 inches by 5.125 inches. A typical standard symbol has smaller dimensions than these and, hence, each individual narrow field of view 12L, 12R and 12C by itself does not have the capability to image an entire target 24 whose dimensions are larger than that of a standard symbol.

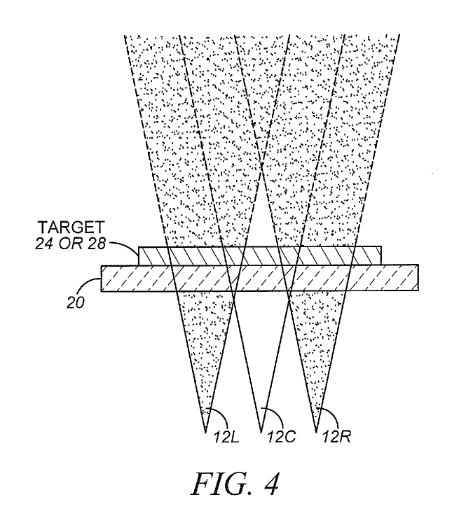

In accordance with this disclosure, the target 24 is placed in stationary, surface area contact with either window, e.g., the horizontal window 20 (see FIGS. 1 and 4). The shape and borders of the window 20 serves as a convenient placement guide. The imaging assembly is also operative for capturing return light from the stationary target 24 over all the plurality of fields of view 12L, 12R and 12C extending along the different directions through the window 20. Each field of view 12L, 12R and 12C bounds an area in the window plane that is smaller than the entire sheet-like target 24. However, as shown in FIG. 4, at least one pair of the fields of view, e.g., 12L and 12C, and/or 12R and 12C, partially overlaps each other in the window plane. Also, the plurality of the fields of view 12L, 12R and 12C overlap a plurality of contiguous portions of the sheet-like target 24 in stationary contact with the at least one window 20 during imaging of the sheet-like target 24.

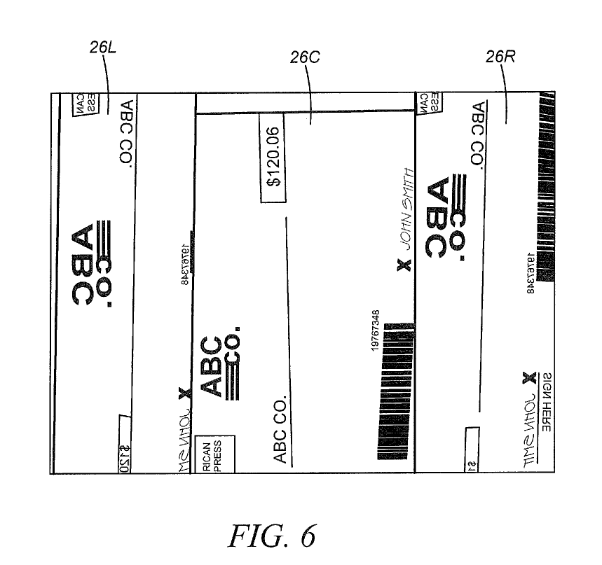

The return light from all the plurality of the contiguous portions is captured by the imaging assembly as a plurality of target images, e.g., a center target image 26C (see FIG. 6) from the center field of view 12C, a left target image 26L (see FIG. 6) from the left field of view 12L, and a right target image 26R (see FIG. 6) from the right field of view 12R. The center target image 26C contains most, but not all, of the target 24, while the left and right target images 26L, 26R contain additional image fragments of the target 24. The left and right target images 26L, 26R are mirror reversed as compared to the center target image, and also are distorted in perspective, due to the folding mirrors in the imaging assembly.

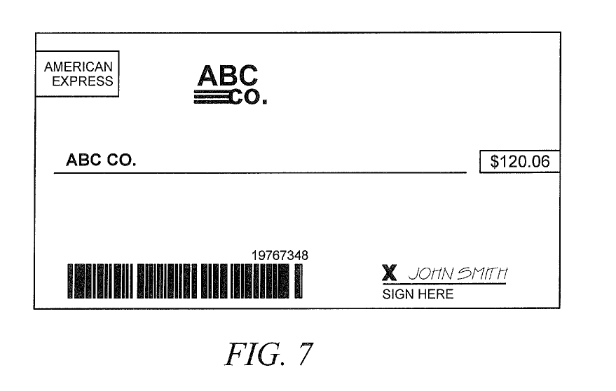

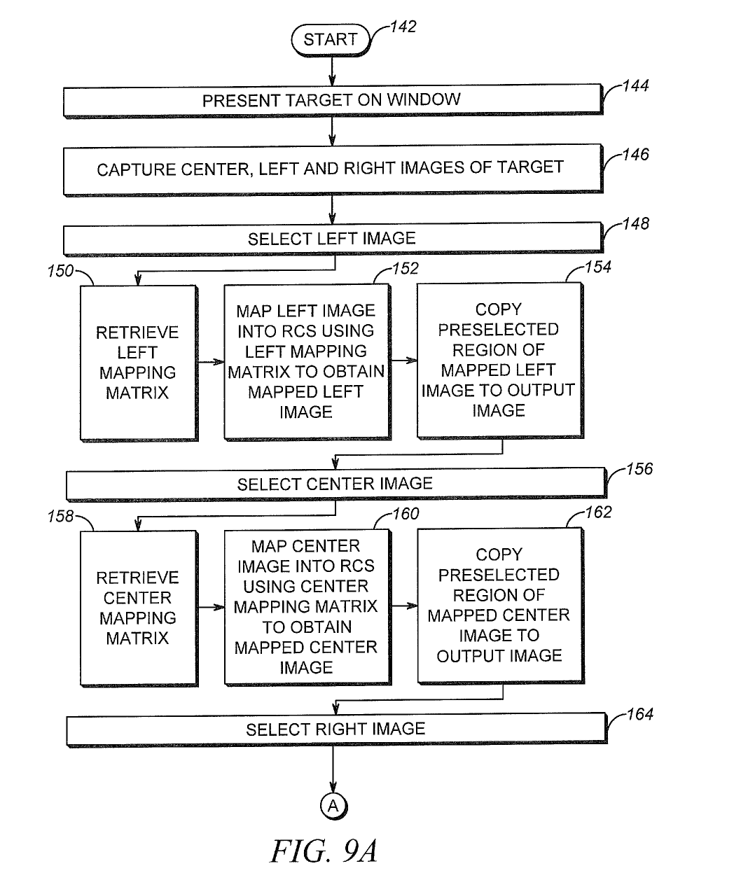

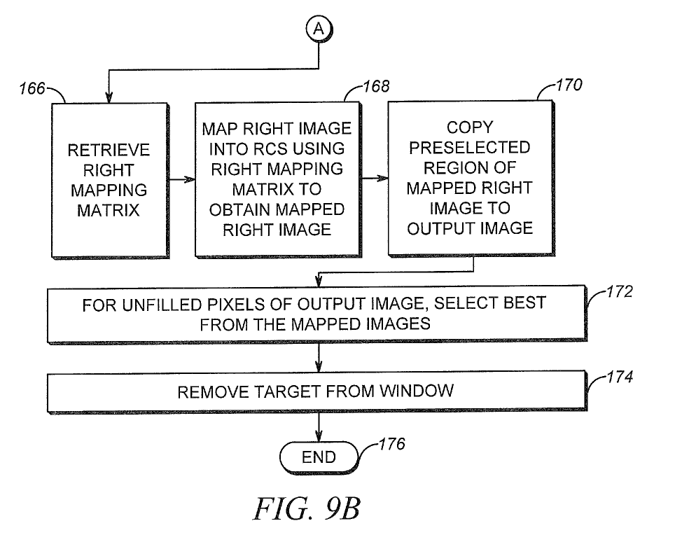

The controller 18 is operative, as described in detail below in connection with FIG. 9, for processing the left and right target images 26L, 26R by rectifying them to account for mirror reflection, and also for correcting them to account for perspective distortion. The controller 18 is further operative for compiling the left and right target images 26L, 26R with the center target image 26C into a single output image indicative of the sheet-like target 24. Such a compiled, reconstructed, single output image of the target 24, exemplified by a check, is shown in FIG. 7.

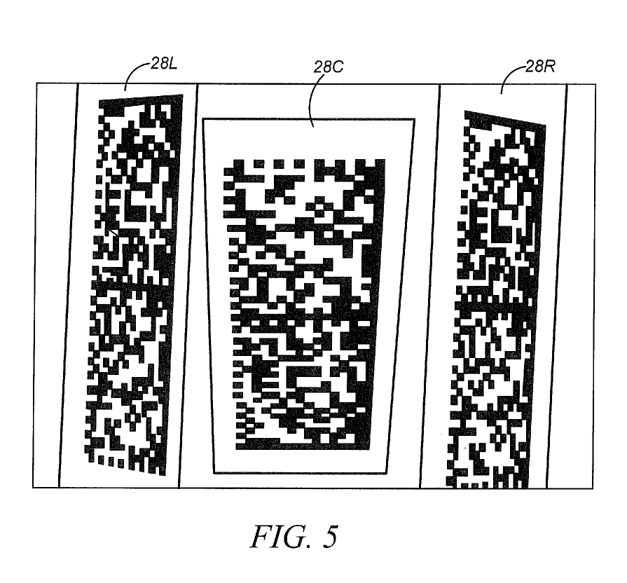

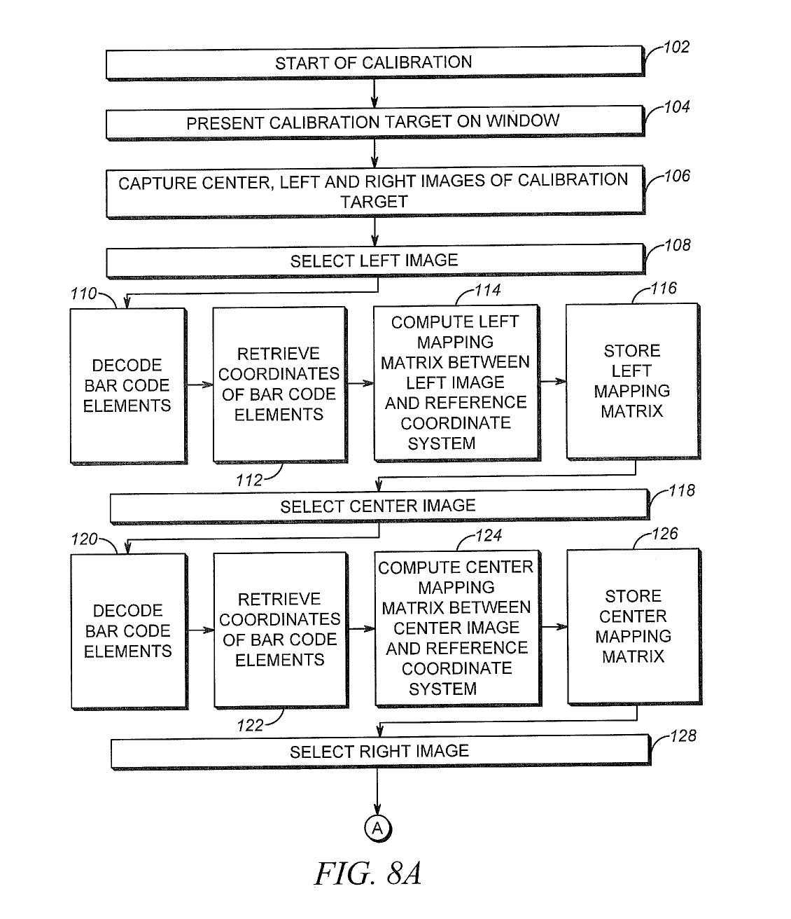

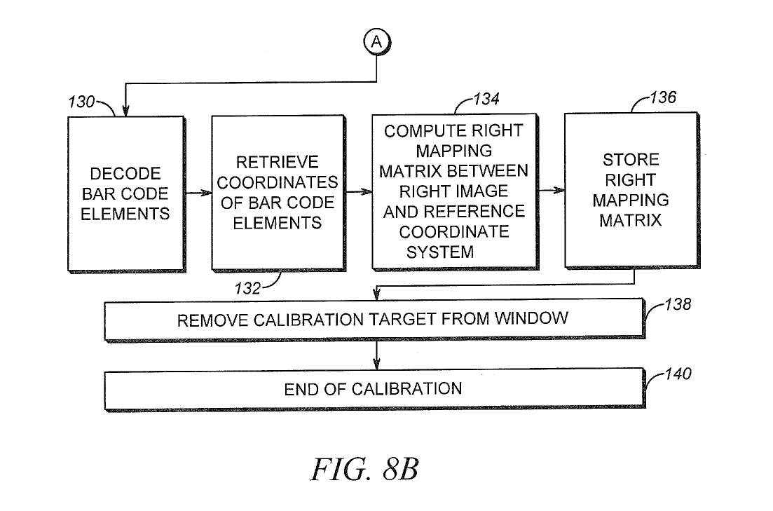

The controller 18 compiles the target images into the single output image of FIG. 7 by using mapping matrices or functions obtained during an advance calibration mode, preferably performed during manufacture of the workstation. As shown in FIGS. 8A and 8B, calibration begins at step 102, and a stationary, sheet-like calibration target 28 (see FIG. 4), e.g., a relatively large, two-dimensional bar code, DataMatrix symbol, is placed in surface area contact with the window 20 in step 104. The shape and borders of the window 20 serves as a convenient placement guide. The imaging assembly now captures center, right and left calibration target images 28C, 28R, and 28L, respectively (see FIG. 5) in step 106.

Next, starting with one of the calibration target images, e.g., the left calibration target image 28L selected in step 108, its bar code content is analyzed and decoded in step 110. Information concerning the coordinates of the bar code elements is retrieved in step 112. A left mapping matrix, as described below, is computed between the left calibration target image 28L and a reference coordinate system (RCS) in step 114. The left mapping matrix is then stored in a memory accessible to the controller 18 in step 116. Next, another one of the calibration target images, e.g., the center calibration target image 28C is selected in step 118, and its bar code content is analyzed and decoded in step 120. Information concerning the coordinates of the bar code elements is retrieved in step 122. A center mapping matrix, as described below, is computed between the center calibration target image 28C and the RCS in step 124. The center mapping matrix is then stored in the memory in step 126. Next, another one of the calibration target images, e.g., the right calibration target image 28R is selected in step 128, and its bar code content is analyzed and decoded in step 130. Information concerning the coordinates of the bar code elements is retrieved in step 132. A right mapping matrix, as described below, is computed between the right calibration target image 28R and the RCS in step 134. The right mapping matrix is then stored in the memory in step 136. The calibration target 28 is removed from the window 20 in step 138, and calibration ends at step 140.

Thus, during calibration, the content of each calibration target image 28L, 28C and 28R is analyzed, and the bar codes in these images are decoded. Then, the information about the relative positions of the pixels that represent the same bar code elements, i.e., the dark and light module coordinates, is retrieved. Since a two-dimensional bar code can be decoded from incomplete images, it is not mandatory that the entire bar code be located in each calibration target image 28L, 28C and 28R.

A separate mapping matrix or function is then derived for each of the calibration target images 28L, 28C and 28R. These functions are intended to transform the calibration target images 28L, 28C and 28R to a common coordinate system, i.e., the RCS. This system can be imagined as an actual camera located directly above the center of the calibration target, with a focal length set to an exact focus. The mapping function then represents the shift and rotation needed to derive the RCS from an actual camera coordinate system as represented by a 3×3 coefficient matrix. This matrix defines a mapping function that is used during later capture of the sheet-like target. Computation using a mapping function can be very rapid.

Each matrix has nine arguments/coefficients/parameters or unknowns and can be solved using nine values. Since there are many more bar code elements then the number of unknowns, then an over-defined system of equations is formed that allows for achieving sub-pixel accuracy of the mapping by means of least square data fitting. It is essential to the performance of the system that mapping be performed with an accuracy greater then a size of a pixel. Only in that case is it possible to restore the image from the three images with a resolution which is no worse than the resolution of the original calibration target images 28L, 28C and 28R. After mapping, calibration arguments of each mapping function are stored, which makes this very efficient, because only three sets of nine numbers are stored, one set for each calibration target images 28L, 28C and 28R.

FIGS. 9A and 9B together constitute a flow chart depicting post-calibration steps performed according to the method of this disclosure. Starting with step 142, the sheet-like target 24 is placed on the window 20 in step 144. In step 146, the return light from the target 24 is captured by the narrow fields of view 12L, 12R and 12C to obtain left, right and center target images 26L, 26R and 26C. Next, starting with one of the target images, e.g., the left target image 26L selected in step 148, the left mapping matrix (previously stored in step 116) is retrieved in step 150. Then, in step 152, the left target image 26L is mapped into the RCS using the retrieved left mapping matrix to thereby obtain a mapped left image. In step 154, a preselected region or fragment of the mapped left image is copied to the output image. Next, another one of the target images, e.g., the center target image 26C is selected in step 156, and the center mapping matrix (previously stored in step 126) is retrieved in step 158. Then, in step 160, the center target image 26C is mapped into the RCS using the retrieved center mapping matrix to thereby obtain a mapped center image. In step 162, a preselected region or fragment of the mapped center image is copied to the output image. Next, another one of the target images, e.g., the right target image 26R is selected in step 164, and the right mapping matrix (previously stored in step 136) is retrieved in step 166. Then, in step 168, the right target image 26R is mapped into the RCS using the retrieved right mapping matrix to thereby obtain a mapped right image. In step 170, a preselected region or fragment of the mapped right image is copied to the output image.

The compiling takes the preselected image fragments from each target image that are known in advance to yield a high quality image. For example, most of the image fragments or pixels from the center target image 26C are known not to be distorted, and therefore of good quality. Then, the unfilled pixels from the right and left target images that have not yet been used are added to stitch or fill in any blank areas in the center target image. When there are two or more candidate pixels for a particular position, then they can be tested, in step 172, for maximum contrast, or for a certain color, or other criterion, or the candidate pixel from the center target image can be given priority. Further image improvement can include color equalization, or thresholding to form a bi-level image. The target 24 is removed from the window 20 in step 174, and the image capture of the sheet-like target 24 ends at step 176.

The reconstructed check in FIG. 7 has missing parts in its corners, because these parts were not imaged by any of the fields of view. Nevertheless, the reconstructed check image contains all the needed information, e.g., bank name, account number, payor name and payor address, and hence is adequate for its intended purpose. The reconstruction is rapid, because only the mapping coefficients/parameters of each matrix need to be retrieved.

In the foregoing specification, specific embodiments have been described. However, one of ordinary skill in the art appreciates that various modifications and changes can be made without departing from the scope of the invention as set forth in the claims below. For example, as described above, three images were taken of the calibration target 28 and the sheet-like target 24. It will be understood that the number of such images can be different. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements, but may include other elements not expressly listed or inherent to such process, method, article, or apparatus. An element proceeded by “comprises . . . a,” “has . . . a,” “includes . . . a,” or “contains . . . a,” does not, without more constraints, preclude the existence of additional identical elements in the process, method, article, or apparatus that comprises, has, includes, or contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1%, and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors, and field programmable gate arrays (FPGAs), and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein, will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A point-of-transaction workstation for processing a product by imaging an indicium associated with the product in a transaction, and for imaging a stationary, sheet-like target associated with the transaction, comprising:
a housing;
at least one light-transmissive, generally planar window supported in a window plane by the housing, and being in surface area contact with the sheet-like target during imaging of the sheet-like target;
an imaging assembly having at least one solid-state imager stationarily supported by the housing, and operative for capturing return light from the indicia during processing of the product, and from the sheet-like target during imaging of the sheet-like target, over a plurality of stationary fields of view extending along different directions through the at least one window, each field of view bounding an area in the window plane that is smaller than the entire sheet-like target, at least one pair of the fields of view partially overlapping each other in the window plane, and the plurality of the fields of view overlapping a plurality of contiguous portions of the sheet-like target in stationary contact with the at least one window during imaging of the sheet-like target, the return light from the plurality of the contiguous portions being captured by the imaging assembly as a plurality of target images; and
a controller operatively connected to the at least one imager, for compiling the target images into a single output image indicative of the sheet-like target.

2. The workstation of claim 1, wherein the fields of view include a center field of view that passes through a central region of the at least one window to enable the imaging assembly to capture a center target image, a right field of view that passes through a left side region of the at least one window to enable the imaging assembly to capture a right target image, and a left field of view that passes through a right side region of the at least one window to enable the imaging assembly to capture a left target image.

3. The workstation of claim 2, wherein the controller processes and rectifies the right and left target images to account for mirror reflection.

4. The workstation of claim 2, wherein the controller processes the right and left target images to account for perspective distortion.

5. The workstation of claim 2, wherein the controller compiles all the target images into the single output image by using mapping matrices obtained during an advance calibration mode in which a stationary, sheet-like calibration target is placed in surface area contact with the at least one window to enable the imaging assembly to capture center, right and left calibration target images, and in which the controller processes the calibration target images to store the mapping matrices indicative of the relationships among the calibration target images.

6. The workstation of claim 1, wherein the controller tests candidate pixels from the target images to fill unfilled pixels in the single output image.

7. The workstation of claim 1, wherein the at least one window is a placement guide for the sheet-like target.

8. The workstation of claim 1, wherein the at least one window is a horizontal window of a bi-optical workstation.

9. The workstation of claim 1, wherein the sheet-like target is selected from a group of generally planar targets comprising at least one of checks, medical prescriptions, drivers' licenses, receipts, credit/debit/loyalty cards, coupons, and like documents, sheets, forms and cards.

10. A method of processing a product by imaging an indicium associated with the product in a transaction, and of imaging a stationary, sheet-like target associated with the transaction, comprising:
supporting at least one light-transmissive, generally planar window in a window plane;
placing the sheet-like target in surface area contact with the at least one window during imaging of the sheet-like target;
capturing return light from the indicia during processing of the product, and from the sheet-like target during imaging of the sheet-like target, with an imaging assembly having at least one solid-state imager, over a plurality of stationary fields of view extending along different directions through the at least one window, each field of view bounding an area in the window plane that is smaller than the entire sheet-like target, at least one pair of the fields of view partially overlapping each other in the window plane, and the plurality of the fields of view overlapping a plurality of contiguous portions of the sheet-like target in stationary contact with the at least one window during imaging of the sheet-like target, the return light from the plurality of the contiguous portions being captured by the imaging assembly as a plurality of target images; and
compiling the target images into a single output image indicative of the sheet-like target.

11. The method of claim 10, wherein the fields of view include a center field of view that passes through a central region of the at least one window to enable the imaging assembly to capture a center target image, a right field of view that passes through a left side region of the at least one window to enable the imaging assembly to capture a right target image, and a left field of view that passes through a right side region of the at least one window to enable the imaging assembly to capture a left target image.

12. The method of claim 11, wherein the compiling is performed by rectifying the right and left target images to account for mirror reflection.

13. The method of claim 11, wherein the compiling is performed by correcting the right and left target images to account for perspective distortion.

14. The method of claim 11, wherein the compiling is performed by using mapping matrices obtained during an advance calibration mode in which a stationary, sheet-like calibration target is placed in surface area contact with the at least one window to enable the imaging assembly to capture center, right and left calibration target images, and in which the right and left calibration target images are processed to store the mapping matrices indicative of the relationships among the calibration target images.

15. The method of claim 10, and testing candidate pixels from the target images to fill unfilled pixels in the single output image.

16. The method of claim 10, and configuring the at least one window to serve as a placement guide for the sheet-like target.

17. The method of claim 10, and configuring the at least one window to be a horizontal window of a bi-optical workstation.

18. The method of claim 10, and selecting the sheet-like target from a group of generally planar targets comprising at least one of checks, medical prescriptions, drivers' licenses, receipts, credit/debit/loyalty cards, coupons, and like documents, sheets, forms and cards.
